(19) United States
(12) Patent Application Publication
(10) Pub. No.: US 2003/0041578 A1
(43) Pub. Date: Mar. 6, 2003

(54) Wheeled trimmer

(76) Inventor: Joseph B. Fuller, Spartanburg, SC (US)

Correspondence Address: Joseph T. Guy, Ph.D., Nexsen Pruet Jacobs & Pollard, LLC, PO Drawer 10648, Greenville, SC, 29603-0648, US

(21) Appl. No.: 09/944,922

(22) Filed: Aug. 31, 2001

(51) Int. Cl. B62D 61/06; A01D 34/67; A01D 34/84; A47L 13/00; B25G 1/06

(52) U.S. Cl. 56/12.7; 56/16.7; 280/62; 15/144.2

(57) ABSTRACT

A trimmer which is particularly useful for trimming uneven terrain. The trimmer comprises a base with a motor attached to the base. The motor is also attached to, and rotates, a cutting element wherein the cutting element comprises at least one line. Two unidirectional wheels and a multidirectional wheel are attached to the base. A handle is connected to the base by a universal joint.

### TECHNICAL FIELD

The present invention is related to wheeled trimmer. More specifically, the present invention is related to a wheeled rotating line trimmer with enhanced mobility and ease of use.

### BACKGROUND

Rotating line trimmers are common in the art and their use is well understood. Rotating line trimmers are particularly useful in locations and circumstances where mowers are difficult to maneuver. A particular use of rotating line trimmers is in small areas where a mower is not warranted due to the issues associated with storage, noise, expense and others well known in the art.

A particular advantage of rotating line trimmers is the ability to cut uneven terrain, such as banks and hills, without the potential for rolling which is a constant possibility with conventional mowers. Though advantageous, rotating line trimmers are difficult to use on banks since the operator must stand on the bank and attempt to hold the rotating line trimmer in an orientation with the rotating line parallel to the terrain. This is difficult and often leads to an uneven cut and gauging. As well known this causes an unsightly cut which is undesirable.

There are many rotating line trimmers which have been developed specifically to insure that the line rotates parallel to the terrain being cut. Most of these involve a platform of some type on which a rotating line trimmer is mounted either permanently or reversibly. Exemplary references include U.S. Pat. Nos. 5,839,262; 5,287,683; 4,756,147; 4,688,376; 4,428,183; 4,411,126; 4,389,836 and 4,343,139. All of these rotating line trimmers have the advantage of insuring that the rotating line is parallel to the surface yet they also have a common deficiency. In each case the relationship between the handle and rotating line is fixed. This deficiency requires that the person using the rotating line trimmer must be directly behind the trimmer to effectively cut an area. For example, if the operator wishes to turn the trimmer to their right the operator must effectively step to their left to pivot the trimmer on the rear wheels thereby rotating the orientation of the trimmer. This requires the operator to essentially move in a direction which is the mirror image of the trimmer. Since the distance between the wheels and rotating line is less than the distance between the wheels and the operator the movement of the operator is exaggerated relative to the movement of the trimmer. This greatly increases fatique.

If an uneven terrain is to be trimmed, such as a steep ditch bank, the operator has three options. The operator can stand on the upper side of the bank and trim up and down the bank. This is difficult since the weight of the trimmer must be pulled up the bank with each swath cut. Furthermore, the operator must lean over the bank to achieve a reasonable reach down the bank. If the operator stands below the bank the trimmer must be pushed up the hill which is difficult and tiring. If the operator walks parallel to, and therefore on, the bank they risk the danger of falling or slipping on the bank which is undesirable. Furthermore, if the operator stands on the bank to cut parallel to the bank the trimmer tends to slide downhill which is difficult to control. This is particularly a problem when casters are used as exemplified in U.S. Pat. No. 5,287,683 since the stability offered by stationary wheels is lost.

There has been a long felt need in the art for a rotating line trimmer which allows for ease of use with minimal effort and which can be easily used on uneven terrain such as hills and banks.

### SUMMARY

It is an object of the present invention to provide a rotating line trimmer which is easy to use and which decreases the rate at which an operator is fatigued.

It is another object of the present invention to provide a rotating line trimmer which allows for safe and efficient operation on slopes.

These and other advantages, as will be realized from the disclosure herein, are provided in a trimmer comprising a base with a motor attached to the base. The motor is also attached to, and rotates, a cutting element wherein the cutting element comprises at least one line. Two unidirectional wheels and a multidirectional wheel are attached to the base. A handle is connected to the base by a universal joint.

Another embodiment is provided in a rotating line trimmer. The rotating line trimmer comprises a base with a front and a rear. A motor driven rotating line cutter element is attached to the base. Two unidirectional wheels attached to the front of the base and a multidirectional wheel is attached to the rear of the base. A handle is attached to the rear of the base with a dual pivoting joint.

Yet another embodiment is provided in a trimmer comprising a rotating line cutting device. A handle attachment element is attached to the rotating line cutting device wherein the handle attachment device comprises a first pivot and a second pivot. The first pivot point and the second pivot are capable of pivoting simultaneously. A handle is attached to the handle attachment element.

### DESCRIPTION OF DRAWINGS

FIG. 1 is a perspective view of an embodiment of the present invention.

FIG. 2 is a schematic representation of the relative movement of the handle and base of the present invention.

FIG. 3 is a view of the back of an embodiment of the present invention.

FIG. 4 is a front view of the inventive device illustrating one utility and specific advantage which is the use in trimming slopes.

### DETAILED DESCRIPTION

The present invention is directed to a rotating line trimmer which utilizes a combination of fixed wheels and rotating wheels and a dual pivoting handle to increase the ability of the operator to control the device.

The invention will be described in reference to the drawings wherein similar elements are numbered accordingly.

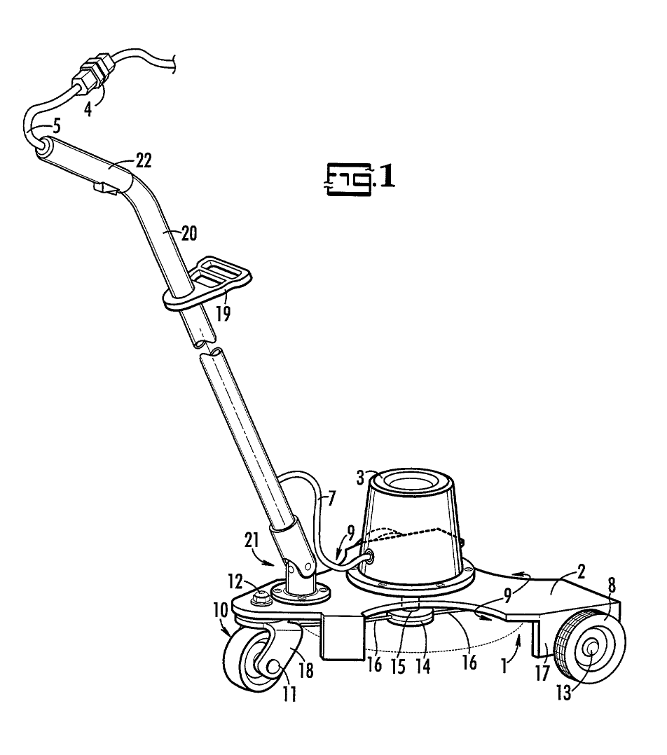

A rotating line trimmer, generally represented at 1, is illustrated in perspective view in FIG. 1. The rotating line trimmer comprises a base, 2, which serves the function of a central structure upon which all other elements may be attached. The shape and size of the base is chosen to be large enough to adequately support a motor, 3, and associated elements such as gas tanks, cord conduits etc. A generally trigonal base is most preferred since this allows the base to be stable and less susceptible to tipping without requiring the base to be excessively large. The base may comprise a lip, 17, extending downward to divert debris which is spread outward as well known with rotating line cutters. An inward recess, 9, may be formed in the side or front of the base to allow the cutting line to be brought into closer proximity with fence post, trees and the like while still providing the protection offered by the base.

The base is constructed of any material common in the manufacture of rotating line trimmers. The preferred material is lightweight with sufficient strength to support the weight of a motor. Particularly preferred are metals, such as aluminum, alloys and synthetic materials such as reinforced composites and the like.

The motor is any motor known in the art of rotating line trimmers including electric motors and liquid fuel, such as gasoline, motors. In the embodiment of FIG. 1 the motor is electric as typically used with standard 120 volt household current. A plug, 4, attaches to a power source as would be realized to one of ordinary skill in the art. The plug is in electrical communication with the motor through a wire, 5, which preferably is enclosed in a handle, 20, and optional wire chase, 7. The wire chase is preferably a tube which may also be secured to, or integral to, the base for enclosing and protecting the wire.

The handle is preferably an elongated hollow member since this allows an electrical cord to be concealed therein if desired. The end opposite the trimmer is preferably angled such that the grip, 22, is approximately parallel to the ground at typical user heights. A grip, 22, is preferred to increase the control of the trimmer. The handle is preferably round but other shapes, such as polygonal, are within the scope of the present invention. The material of construction is not limiting with metal, specifically aluminum, being preferred due to the light weight and low cost.

The manner in which the motor is secured to the platform is not limiting. The motor may be attached by a combination of threaded members, such as a nut and bolt, or the motor may comprise matching protrusions and slots such as described in U.S. Pat. No. 4,389,836. It is imperative that the manner in which the motor is attached to the base is sufficient to withstand the vibrations which are inherent in the operation of a rotating line trimmer.

The rotating line trimmer comprises three wheels. The front wheels, 8, are unidirectional wheels. The rear wheel, 10, is a multidirectional wheel. Each unidirectional wheel is attached to a fixed axle, 13. In one embodiment both unidirectional wheels may be attached to a common axle. The multidirectional wheel, also referred to as a caster wheel, rotates freely on an attachment axle, 12, thereby allowing the direction of the wheel to change in response to the movement of the trimmer. The rear wheel is mounted on a wheel axle, 11, in a bracket, 18, which is rotatably attached to the attachment axle, 12. An optional locking mechanism for reversibly locking the multidirectional wheels in a preferred rotational position is preferred.

A cutting assembly, 14, is attached to the output shaft, 15, of the motor, 3. At least one line, 16, extends from the cutting assembly. The motor rotates the output shaft which, in turn, rotates the cutting assembly. The line rotates below the base and cuts grass or other vegetation with which it comes into contact as well known in the art of rotating line cutters.

A particular advantage of the present invention is provided by the manner in which the handle, 20, is attached to the base, 2. The handle is attached to the base by a dual pivoting or universal joint, 21. The universal joint is capable of transmitting rotation from the handle to the mounting bracket regardless of the linear relationship therebetween. The universal joint allows the handle to be in any position while still maintaining a fixed rotational relationship between the grip, 22, and the base, 2. As the handle is rotated around the long axis, the rotation causes the base to rotate in the same direction. The rear multidirectional wheel allows free movement of the rear of the base. Therefore, the combination of a rear multidirectional wheel and a handle attached by a universal joint allows the rotating line trimmer to be easily maneuvered. An optional but preferred lower grip, 19, reversibly secured to the handle provides additional control over the rotating line trimmer and assist in the rotation of the handle. The lower grip is preferably secured by pressure wherein opposing pieces are brought into contact with the handle.

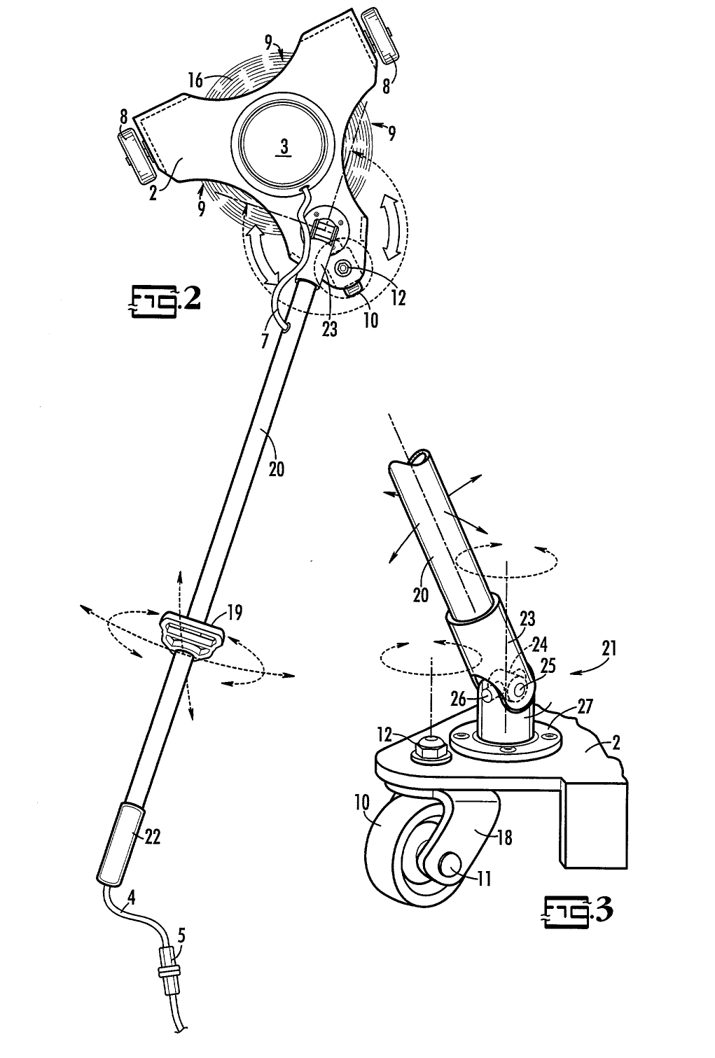

As shown in FIG. 2, the rotation of the handle and the rotational orientation of the base are integral. As the handle is rotated clockwise the base moves accordingly.

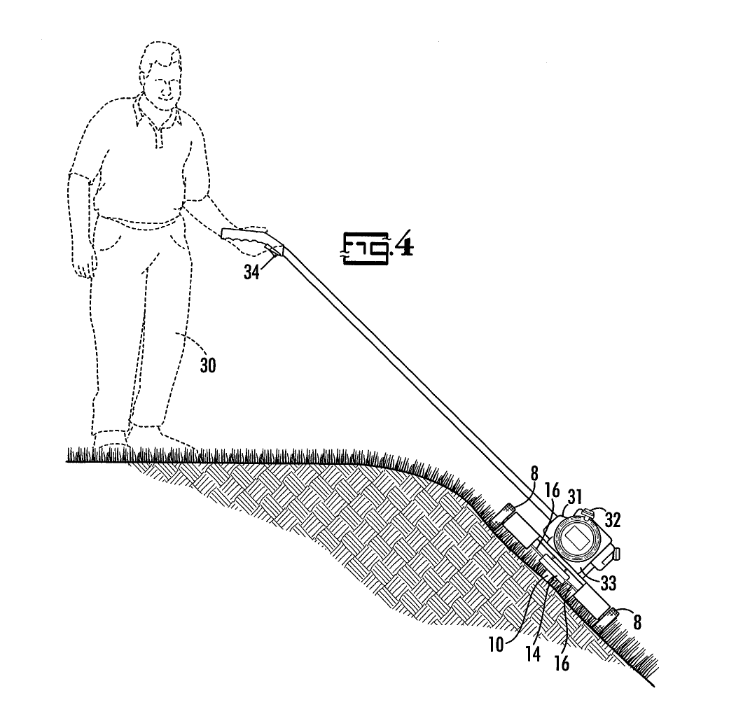

The universal joint, 21, is shown in closer view in FIG. 3. The universal joint is a dual pivoting joint comprising a handle coupling, 23, which is rotatably attached to a link, 24, by a first axle, 25 which forms a first pivot. Also rotatably attached to the link, 24, by a second axle, 26, is a bracket, 27. The second axle forms a second pivot. The bracket, 27, is secured to the base, 2. The first axle and second axle are not parallel. More preferably, the first axle and second axle are approximately perpendicular as commonly employed with universal joints. The universal joint has been described with particular emphasis drawn to the preferred embodiments. Other construction consistent with the dual pivoting function could be employed without departing from the scope of the invention.

As the handle is raised and lowered the link pivots on the first axle, 25. As the handle is moved from left to right the handle couple pivots on the second axle, 26. Therefore, the operator can push the trimmer forward and twist the handle clockwise which will cause the trimmer to move to the operators right as illustrated in FIG. 2. It would be apparent from the description that the further the handle is turned the more the trimmer rotates.

While many advantages will be apparent from the description provided, a particular advantage is offered in the ease with which a slope can be cut utilizing the present invention.

The use of the device for cutting a slope will be described by reference to FIG. 4. As with prior art devices, the rotating line trimmer is allowed to roll partially down a bank. The operator 30, rotates the handle in a clockwise rotation thereby causing the rotating line trimmer to also pivot in a clockwise direction. The handle is rotated until the rotating line trimmer is perpendicular to the handle, or parallel to the bank, as shown in FIG. 4 wherein the rotating line trimmer is shown in front view facing the same direction as the operator, 30. The operator can then walk along the bank with the trimmer below and moving parallel to the operator. It would be apparent that the operator could cut in the opposite direction by rotating the handle counter-clockwise. It would also be apparent that the operator could be below the bank with the rotating line trimmer above the operator with the same results. This ability to walk behind, beside, or an intermediate position relative to the direction of movement of the rotating line trimmer is not currently available in the art of rotating line trimmers and greatly enhances the utility of rotating line trimmers.

In the embodiment of FIG. 4, a liquid fuel motor, 31, is illustrated. The liquid fuel motor comprises a pull start handle, 32, fuel tank, 33 and throttle, 34.

The line corresponds to line currently employed in the art of rotating line trimmers. Specifically included are monofiliment lines, multifilament lines, extruded lines, chains and the like.

The invention has been described with specific emphasis on the preferred embodiments. Other embodiments, modifications and design changes can be envisioned without departing from the scope of the present invention which is set forth in the claims which are appended hereto.

Claimed is:

1. A trimmer comprising:
a base;
a motor attached to said base wherein said motor is attached to and rotates a cutting element wherein said cutting element comprises at least one line;
two unidirectional wheels attached to said base;
a multidirectional wheel attached to said base;
a handle; and
a universal joint connecting said handle to said base.

2. The trimmer of claim 1 wherein said base comprises a recess.

3. The trimmer of claim 1 further comprising a lower grip attached to said handle.

4. The trimmer of claim 1 wherein said universal joint comprises:
a handle couple attached to said handle;
a link rotatably attached to said handle couple; and
a bracket rotatably attached to said link and attached to said base.

5. The trimmer of claim 1 wherein said motor is an electric motor.

6. A rotating line trimmer comprising:
a base comprising a front and a rear;
a motor driven rotating line cutter element attached to said base;
two unidirectional wheels attached to said front of said base;
a multidirectional wheel attached to said rear of said base; and
a handle attached to said rear of said base with a dual pivoting joint.

7. The rotating line trimmer of claim 6 wherein said dual pivoting joint comprises a first pivot and a second pivot.

8. The rotating line trimmer of claim 7 wherein said first pivot and said second pivot are not parallel.

9. The rotating line trimmer of claim 8 wherein said first pivot and said second pivot are perpendicular.

10. The rotating line trimmer of claim 6 wherein said motor is an electric motor.

11. A trimmer comprising:
a rotating line cutting device;
a handle attachment element attached to said rotating line cutting device wherein said handle attachment device comprises a first pivot and a second pivot wherein said first pivot point and said second pivot are capable of pivoting simultaneously; and
a handle attached to said handle attachment element.

12. The trimmer of claim 11 further comprising two unidirectional wheels.

13. The trimmer of claim 11 further comprising a multidirectional wheel.

14. The trimmer of claim 11 wherein said rotating line device comprises a base and a motor attached to said base and wherein said motor rotates a line.

15. The trimmer of claim 11 wherein said handle attachment element is a universal joint.

16. The trimmer of claim 11 wherein said first pivot and said second pivot are not parallel.

17. The trimmer of claim 16 wherein said first pivot and said second pivot are perpendicular.
